(19) United States
(12) Patent Application Publication
(10) Pub. No.: US 2004/0103085 A1
(43) Pub. Date: May 27, 2004

(54) System and process for automated management and deployment of web content

(76) Inventors: Pierre O. Ly, Richmond, VA (US); Steve Passino, Scottesville, VA (US); H. Brian Diener, Glen Allen, VA (US); Aleksandr Livshits, West Hartford, CT (US); Michael Bolt, Forest, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/301,668

(22) Filed: Nov. 22, 2002

(51) Int. Cl. G06F 7/00

(52) U.S. Cl. 707/3

(57) ABSTRACT

The present invention provides for a system and process for automated management and deployment of web content. Digital files for web content update are included in archived documents and stored in designated storage locations that are scanned automatically. The archived documents are evaluated and, if they meet predetermined criteria, copied to designated web-hosting servers. The web-hosting servers are scanned automatically for available archived documents, and are updated with the digital files extracted from the available archived documents. The present invention provides automated web content update at a system-wide scale without any web developer's direct access to the server(s) being updated. Therefore static web content is updated frequently while service interruption of the web environment is minimized.

### BACKGROUND OF THE INVENTION

The present invention relates to the field of digital file management. More particularly, the present invention relates to automated update of static content on web servers and/or application servers.

Many business web sites store a large volume of static content on their web servers and/or application servers. Static content is any web content that is saved to storage media and passed back to a requesting browser without changes. Most commonly seen static content includes at least the following file types: executables, images, hypertext, Microsoft™ documents, and Acrobat™ documents. Static content may require frequent updates to provide customers with fresh information.

Traditional approaches to update web content involve manual creation of archive files, interruption of web service for several hours to upload new files,. recompiling of web pages and/or applications, restarting of the web and/or application servers, and a cycle time of several days to rigorously test the above-mentioned web environments. Such approaches are not only cumbersome for the web developers but inconvenient for the customers as well. Interruption of web service may cause customer dissatisfaction. Long cycle time to test restarted servers may lead to infrequent update of the servers.

These and other drawbacks exist.

### BRIEF SUMMARY OF THE INVENTION

Accordingly, the present invention is directed to a system and process for automated static web content management and deployment that overcome these and other drawbacks of present systems and methods.

It is an advantage of the present invention to automatically update the static content on a web server and/or application server at a system-wide scale on a routine basis.

It is another advantage of the present invention to update the content on a web server and/or application server without any web developer's direct access to the server(s) being updated, therefore minimizing service interruption of the above-mentioned web environments.

Additional advantages of the invention will be set forth in part in the description, or may be learned by practice of the invention. The advantages of the invention may be realized and attained by means of instrumentalities and combinations particularly pointed out in the appended claims and are not limited to those described above.

To achieve these advantages and in accordance with the purpose of the invention, as embodied and broadly described herein, a process for automated management and deployment of static web content, comprises the steps of scanning at least one designated storage location for at least one archived document, where the at least one archived document contains at least one digital file, selecting at least one of the at least one archived document that meets at least one predetermined criterion, copying the at least one selected archived document to a designated location, scanning the designated location for at least one selected archived document, and updating at least one designated server with the at least one digital file contained in the at least one selected archived document.

In a further aspect, a computer usable medium has computer readable program code embodied therein for automated management and deployment of static web content, where said computer readable program code comprises instruction means for scanning at least one designated storage location for at least one archived document, where the at least one archived document contains at least one digital file, instruction means for selecting at least one of the at least one archived document that meets at least one predetermined criterion, instruction means for copying the at least one selected archived document to a designated location, instruction means for scanning the designated location for at least one selected archived document, and instruction means for updating at least one designated server with the at least one digital file contained in the at least one selected archived document.

In another aspect, a system for automated management and deployment of static web content comprises means for scanning at least one designated storage location for at least one archived document, where the at least one archived document contains at least one digital file, means for selecting at least one of the at least one archived document that meets at least one predetermined criterion, means for copying the at least one selected archived document to a designated location, means for scanning the designated location for at least one selected archived document, and means for updating at least one designated server with the at least one digital file contained in the at least one selected archived document.

In yet another aspect, a system for automated management and deployment of static web content comprises at least one content-management server, where each content-management server comprises, at least one Central Processing Unit (CPU), at least one memory device, at least one storage device, and at least one network interface, at least one web-hosting server, where each web-hosting server comprises: at least one Central Processing Unit (CPU), at least one memory device, at least one storage device, and at least one network interface, means for communicating between the at least one content-management server and the at least one web-hosting server, scanning module for scanning at least one designated storage location for at least one archived document, where the at least one archived document contains at least one digital file, identification module for selecting at least one of the at least one archived document that meets at least one predetermined criterion, duplication module for copying the at least one selected archived document to a designated location, a second scanning module for scanning the designated location for at least one selected archived document, and updating module for updating at least one designated server with the at least one digital file contained in the at least one selected archived document.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate an embodiment of the invention and, together with the description, serve to explain the principles of the invention.

FIG. 1 is a flowchart illustrating steps in a process for updating static web content according to an embodiment of the invention.

FIG. 2 is a schematic representation of a system for updating static web content according to another embodiment of the invention.

FIG. 3 is a schematic representation of a system for updating static web content according to yet another embodiment of the invention.

### DETAILED DESCRIPTION OF THE INVENTION

Reference will now be made in detail to the present embodiments of the invention, examples of which are illustrated in the accompanying drawings.

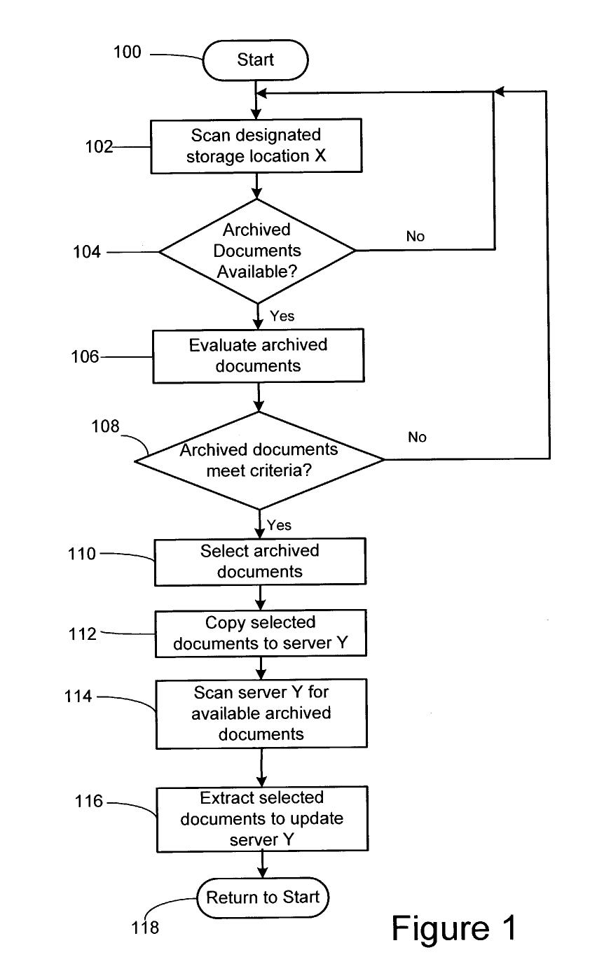

FIG. 1 is a flowchart illustrating steps in a process for updating static web content according to an embodiment of the invention. The process starts from step 100. At step 102, a designated storage location X is scanned for available archived documents. According to an embodiment of the invention the designated storage location X may be a designated file directory on a networked content-management server. The content-management server may be a computer workstation dedicated to the management and deployment of web content. According to one embodiment of the invention, the content-server may be any server that is running some flavor of UNIX operation system.

If archived documents are found, they are evaluated, at step 106, to verify whether they meet predetermined criteria. If an archived document meets predetermined criteria, it is selected at step 110. The predetermined criteria may include the size of each of the selected archived documents, the file type of each of the digital files contained in the selected archived documents, the file path of each of digital files contained in the selected archived documents, or the intended destination of the digital files contained in the selected archived documents. According to an embodiment of the invention, predetermined criteria may be adopted to ensure that the selected archived documents contain only digital files applicable for static content update.

In one embodiment of the present invention, where the web-hosting server is a Sun™ iPlanet™ Web Server, the predetermined criteria may be defined as: (1) the size of the selected archived documents, e.g. Tape ARchive (TAR) documents, does not exceed 50 MB; (2) all files contained in the TAR documents are relative pathed, with respect to the web site's document root; and (3) each of the files contained in the TAR documents is of one of the following types: .exe, .pdf, .htm, .html, inc, gif, .jpg, .css, .shtml, .doc, .xls, tif, .ppt, or .ttf.

At step 112, the selected archived documents are copied to a web-hosting server Y. The web-hosting server Y may be a web server or an application server. According to one embodiment of the invention, the web-hosting server Y is a Sun™ ONE Web Server or a Sun™ ONE Application Server.

In one embodiment of the invention, the storage location X may be designated to store archived documents containing digital files intended for web-hosting server Y only. That is, each web-hosting server Y may have a separate storage location X which will store the archived documents for that web-hosting server. Alternatively, archived documents containing digital files intended for different web-hosting servers may be stored in a same designated storage location. In this configuration, identification of the intended destination (web-hosting server) for the digital files contained in an archived document may be embedded in the archived document. According to one embodiment of the invention, predetermined criteria may include the identification of the web-hosting server that the archived document is intended for. Such information is evaluated at step 106 and is further used at step 112 to determine the web-hosting server that the selected archived document is copied to. Other configuration may also exist.

At step 114, the web-hosting server Y is scanned for available archived documents. If at least one archived document is found, the digital files are extracted, at step 116, from the at least one archived document into a designated storage location on the web-hosting server Y. According to one embodiment of the invention, the designated location may be the document root directory of the web-hosting server Y, with respect to which the digital files are relative pathed.

According to an embodiment of the invention, there may exist a number of different designated storage location X's (e.g. X1, X2, X3 et al.). X1, X2, X3 et al. may be different file directories on a same networked content-management server, or different distributed content-management servers, or a combination thereof. Accordingly, there may exist a number of different web-hosting server Y's (e.g. Y1, Y2, Y3 et al.), where Y1 corresponds to X1, Y2 to X2, Y3 to X3, and so forth. Web developers for each web-hosting server are instructed to include updated digital files, whenever they become available, in archived documents and store them in a designated storage location that corresponds to the web-hosting server that is to be updated. Such embodiments enable web content update in a complex web-environment comprising a number of networked content-management servers and web-hosting servers.

A feature of the invention provides that the process steps 100 to 118 may be scheduled to run at specified times of a day and/or cycle on a periodic basis. In one embodiment of the invention, the process steps 100 to 112 may be set up to run, by way of example, at 9 am, 2 pm, and 7 pm, to scan for available archived documents and copy selected archived documents to appropriate web-hosting servers. Process steps 114 to 118 may be set up to run at 10 am, 3 pm, and 8 pm, to scan for available selected archived documents and extract digital files from the selected archived documents into designated locations on appropriate web-hosting servers. This feature enables frequent and automatic update of the web content, so that customers of a business web site will have access to the most up-to-date information.

Another feature of the invention provides that the process steps 100 to 118 may be set up to run automatically upon occurrence of a plurality of specified event. By way of example, the process may be set up to run whenever a web-hosting server has been restarted. The process may also be configured to be able to be triggered by other events from inside or outside the web environments. This feature of the invention further increases the flexibility in the operation of this web content updating process.

According to embodiments of the present invention, one or more features of the present invention may be implemented on one or more processors using UNIX and/or shell scripting.

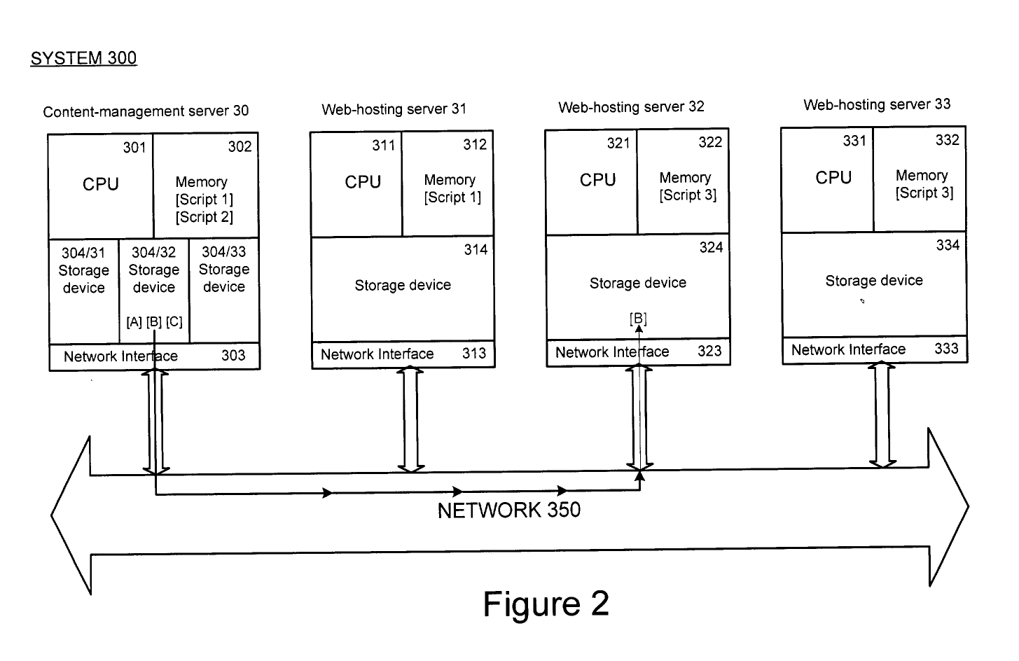

FIG. 2 illustrates a System 300 according to one embodiment of the present invention. System 300 comprises content-management server 30, and web-hosting servers 31, 32 and 33, that are connected with a network 350. Each networked server comprises at least one Central Processing Unit (CPU), one memory device, at least one storage device and one network interface. Each networked server is capable of running program scripts that reside in its memory device, manipulating files and documents stored on its own storage device and/or a networked storage device, and communicating with other servers via its network interface and the network 350.

For purposes of illustration, one example of automated static content update for System 300 will now be described. At a first scheduled time, CPU 301 of content-management server 30, runs a first script, Script 1, that is residing in memory 302, to scan storage devices 304/31, 304/32 and 304/33 for archived documents. Storage devices 304/31, 304/32 and 304/33 are associated with web-hosting servers 31, 32 and 33, such that appropriate documents to be uploaded to a web-hosting server (e.g., web-hosting server 33) are stored in its associated storage device (e.g., storage device 304/33). If, by way of example, archived documents A, B and C are found on storage device 304/32, these documents will be selected and sent as inputs for a second script, Script 2, which is residing in memory 302. Script 2 runs to cause CPU 301 to examine the selected documents to verify whether they meet predetermined criteria, wherein the predetermined criteria are based, at least, on the size of each of the selected archived documents, the file type of each of the digital files contained in the selected archived documents, the file path of each of digital files contained in the selected archived documents, or the intended destination of the digital files contained in the selected archived documents. If, by way of example, document B meets the criteria, it will be selected and copied, via network 350, to storage device 324 of web-hosting server 32, which corresponds to storage device 304/32.

At a second scheduled time, CPU 311 of web-hosting server 31 runs a third script, Script 3, that is residing in memory 312, to scan for available archived documents in storage device 314. At the same time, CPU 321 of web-hosting server 32 runs a Script 3 that is residing in memory 322, to scan for available archived documents in storage device 324. At the same time, CPU 331, runs a Script 3 that is residing in memory 312, to scan for available archived documents in storage device 334. When CPU 321 finds archived document B on storage device 324, it causes digital files to be extracted from document B into a designated location inside storage device 324. Such digital files then become available as static web content.

Alternatively, according to one embodiment of the invention, CPUs 311, 321 and 331 may be scheduled to run the third script at different times. For example, web-hosting servers 31, 32 and 33 may be serving customers in different time-zones. Therefore, a same scheduled time for updating all three servers may not be desirable.

In another embodiment of the present invention, by way of example, there may exist more than one content-management server. The first, second and third scripts may be distributed on different content-management servers and/or web-hosting servers, or they may reside in one single server, or the combination thereof.

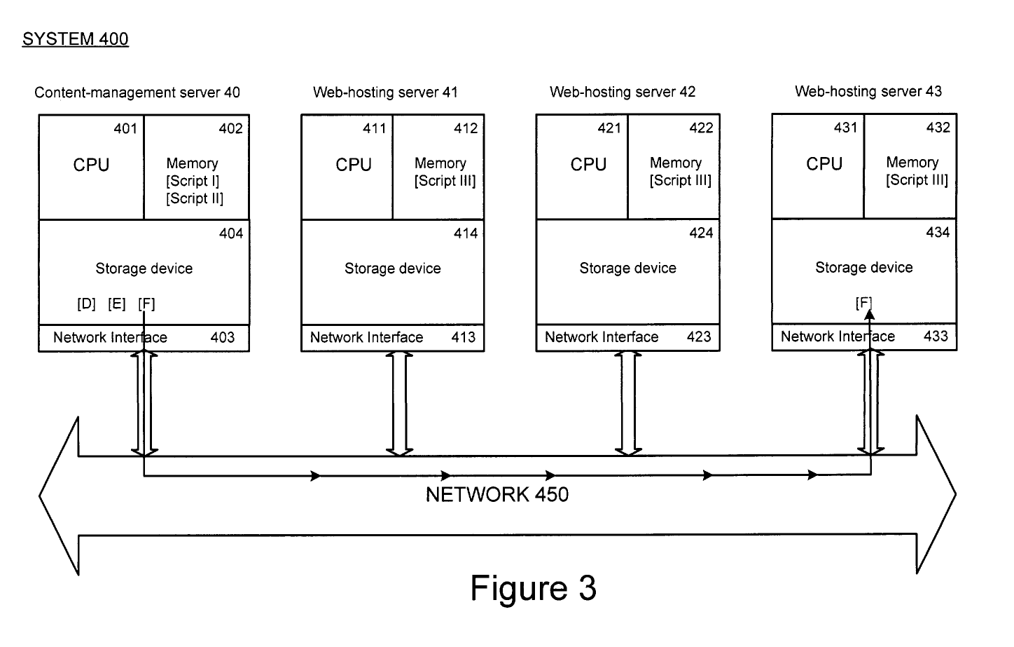

FIG. 3 illustrates a System 400 according to another embodiment of the present invention. System 400 comprises content-management server 30, and web-hosting servers 41, 42 and 43, that are connected with a network 450. Each networked server comprises at least one Central Processing Unit (CPU), one memory device, at least one storage device and one network interface. Each networked server is capable of running program scripts that reside in its memory device, manipulating files and documents stored on its own storage device and/or a networked storage device, and communicating with other servers via its network interface and the network 450.

For purposes of illustration, one example of automated static content update for System 400 will now be described. At a first scheduled time, CPU 401 of content-management server 40, runs a first script, Script I, that is residing in memory 402, to scan storage device 404 for archived documents. If, by way of example, archived documents D, E and F are found on storage device 404, these documents will be selected and sent as inputs for a second script, Script II, which is residing in memory 402. Script II runs to cause CPU 401 to examine the selected documents to verify whether they meet predetermined criteria, wherein the predetermined criteria may include the size of each of the selected archived documents, the file type of each of the digital files contained in the selected archived documents, the file path of each of digital files contained in the selected archived documents, and the intended destination of the digital files contained in the selected archived documents. If, by way of example, document F meets the criteria and information included in document F identifies web-hosting server 43 as its intended destination, document F will be selected and copied, via network 450, to storage device 434 of web-hosting server 43.

At a second scheduled time, CPU 411 of web-hosting serer 41 runs a third script, Script III, that is residing in memory 412, to scan for available archived documents in storage device 414. At the same time, CPU 421 of web-hosting server 42 runs a Script III that is residing in memory 422, to scan for available archived documents in storage device 424. At the same time, CPU 431, runs a Script III that is residing in memory 412, to scan for available archived documents in storage device 434. When CPU 431 finds archived document F on storage device 434, it causes digital files to be extracted from document F into a designated location inside storage device 434. Such digital files then become available as static web content.

Alternatively, according to one embodiment of the invention, CPUs 411, 421 and 431 may be scheduled to run the third script at different times.

Other embodiments, uses and advantages of the present invention will be apparent to those skilled in the art from consideration of the specification and practice of the invention disclosed herein.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A process for automated management and deployment of static web content, the process comprising the steps of:
scanning at least one designated storage location for at least one archived document, where the at least one archived document contains at least one digital file;
selecting at least one of the at least one archived document that meets at least one predetermined criterion;
copying the at least one selected archived document to a designated location;
scanning the designated location for at least one selected archived document; and
updating at least one designated server with the at least one digital file contained in the at least one selected archived document.

2. The process according to claim 1, wherein the at least one predetermined criterion comprises at least one of:
a) size of the at least one selected archived document;
b) file type of the at least one digital file contained in the at least one selected archived document;
c) file path of the at least one digital file contained in the at least one selected archived document;
d) intended destination of the at least one digital file contained in the at least one selected archived document.

3. The process according to claim 1, wherein the step of updating the at least one designated server further comprises the steps of:
backing up at least one digital file stored in a designated location on the at least one designated server;
extracting the at least one digital file from the at least one selected archived document into the designated location on the designated server; and
deleting the at least one selected archived document.

4. The process according to claim 1, wherein the designated location is a storage device.

5. The process according to claim 1, wherein:
the at least one designated storage location comprises a plurality of designated storage locations; and
the at least one server comprises a plurality of servers.

6. The process according to claim 5, wherein the number of the plurality of designated storage locations is equal to the number of the plurality of servers, and each of the plurality of designated storage locations is associated with a separate server, such that the at least one selected archived document used to update one of the plurality of servers is copied to the designated storage location associated with that server.

7. The process according to claim 1, wherein the at least one server comprises a plurality of servers, and
wherein the at least one predetermined criterion includes an identification of one of the plurality of servers.

8. The process according to claim 1, wherein the at least one server is a web server.

9. The process according to claim 1, wherein the at least one server is an application server.

10. A computer usable medium having computer readable program code embodied therein for automated management and deployment of static web content, said computer readable program code comprising:
code for scanning at least one designated storage location for at least one archived document, where the at least one archived document contains at least one digital file;
code for selecting at least one of the at least one archived document that meets at least one predetermined criterion;
code for copying the at least one selected archived document to a designated location;
code for scanning the designated location for at least one selected archived document; and
code for updating at least one designated server with the at least one digital file contained in the at least one selected archived document.

11. The computer usable medium according to claim 10, wherein the at least one predetermined criterion comprises at least one of:
a) size of the at least one selected archived document;
b) file type of the at least one digital file contained in the at least one selected archived document;
c) file path of the at least one digital file contained in the at least one selected archived document;
d) intended destination of the at least one digital file contained in the at least one selected archived document.

12. The computer usable medium according to claim 10, wherein the code for updating the at least one designated server further:
code for backing up at least one digital file stored in a designated location on the at least one designated server;
code for extracting the at least one digital file from the at least one selected archived document into the designated location on the designated server; and
code for deleting the at least one selected archived document.

13. The computer usable medium according to claim 10, wherein the designated location is a storage device.

14. The computer usable medium according to claim 10, wherein:
the at least one designated storage location comprises a plurality of designated storage locations; and
the at least one server comprises a plurality of servers.

15. The computer usable medium according to claim 10, wherein the number of the plurality of designated storage locations is equal to the number of the plurality of servers, and each of the plurality of designated storage locations is associated with a separate server, such that the at least one selected archived document used to update one of the plurality of servers is copied to the designated storage location associated with that server.

16. The computer usable medium according to claim 10, wherein the at least one server comprises a plurality of servers, and
wherein the at least one predetermined criterion includes an identification of one of the plurality of servers.

17. The computer usable medium according to claim 10, wherein the at least one server is a web server.

18. The computer usable medium according to claim 10, wherein the at least one server is an application server.

19. A system for automated management and deployment of static web content, the system comprising:
means for scanning at least one designated storage location for at least one archived document, where the at least one archived document contains at least one digital file;
means for selecting at least one of the at least one archived document that meets at least one predetermined criterion;
means for copying the at least one selected archived document to a designated location;
means for scanning the designated location for at least one selected archived document; and
means for updating at least one designated server with the at least one digital file contained in the at least one selected archived document.

20. The system according to claim 19, wherein the at least one predetermined criterion comprises at least one of:
a) size of the at least one selected archived document;
b) file type of the at least one digital file contained in the at least one selected archived document;
c) file path of the at least one digital file contained in the at least one selected archived document;
d) intended destination of the at least one digital file contained in the at least one selected archived document.

21. The system according to claim 19, wherein the means for updating the at least one designated server further comprises:
means for backing up at least one digital file stored in a designated location on the at least one designated server;
means for extracting the at least one digital file from the at least one selected archived document into the designated location on the designated server; and
means for deleting the at least one selected archived document.

22. The system according to claim 19, wherein the designated location is a storage device.

23. The system according to claim 19, wherein:
the at least one designated storage location comprises a plurality of designated storage locations; and
the at least one server comprises a plurality of servers.

24. The system according to claim 19, wherein the number of the plurality of designated storage locations is equal to the number of the plurality of servers, and each of the plurality of designated storage locations is associated with a separate server, such that the at least one selected archived document used to update one of the plurality of servers is copied to the designated storage location associated with that server.

25. The system according to claim 19, wherein the at least one server comprises a plurality of servers, and
wherein the at least one predetermined criterion includes an identification of one of the plurality of servers.

26. The system according to claim 19, wherein the at least one server is a web server.

27. The system according to claim 19, wherein the at least one server is an application server.

28. A system for automated management and deployment of static web content, the system comprising:
at least one content-management server, where each content-management server comprises: at least one Central Processing Unit (CPU), at least one memory device, at least one storage device, and at least one network interface;
at least one web-hosting server, where each web-hosting server comprises: at least one Central Processing Unit (CPU), at least one memory device, at least one storage device, and at least one network interface;
means for communicating between the at least one content-management server and the at least one web-hosting server;
scanning module for scanning at least one designated storage location for at least one archived document, where the at least one archived document contains at least one digital file;
identification module for selecting at least one of the at least one archived document that meets at least one predetermined criterion;
duplication module for copying the at least one selected archived document to a designated location;
a second scanning module for scanning the designated location for at least one selected archived document; and
updating module for updating at least one designated server with the at least one digital file contained in the at least one selected archived document.

29. The system according to claim 28, wherein the at least one predetermined criterion comprises at least one of:
a) size of the at least one selected archived document;
b) file type of the at least one digital file contained in the at least one selected archived document;
c) file path of the at least one digital file contained in the at least one selected archived document;
d) intended destination of the at least one digital file contained in the at least one selected archived document.

30. The system according to claim 28, wherein the updating module further comprises:
backing-up module for backing up at least one digital file stored in a designated location on the at least one designated server;
extraction module for extracting the at least one digital file from the at least one selected archived document into the designated location on the designated server; and
deletion module for deleting the at least one selected archived document.

31. The system according to claim 28, wherein the designated location is a storage device.

32. The system according to claim 28, wherein:
the at least one designated storage location comprises a plurality of designated storage locations; and
the at least one server comprises a plurality of servers.

33. The system according to claim 28, wherein the number of the plurality of designated storage locations is equal to the number of the plurality of servers, and each of the plurality of designated storage locations is associated with a separate server, such that the at least one selected archived document used to update one of the plurality of servers is copied to the designated storage location associated with that server.

34. The system according to claim 28, wherein the at least one server comprises a plurality of servers, and wherein the at least one predetermined criterion includes an identification of one of the plurality of servers.

35. The system according to claim 28, wherein the at least one server is a web server.

36. The system according to claim 28, wherein the at least one server is an application server.
